(19) United States
(12) Patent Application Publication
(10) Pub. No.: US 2013/0014010 A1
(43) Pub. Date: Jan. 10, 2013

(54) GRAPHICAL USER INTERFACE FOR FINANCIAL DATA, AND RELATED SYSTEM AND METHOD IMPLEMENTING SAME

(76) Inventor: Hartmut Ziegler, Bottighofen (CH)

(21) Appl. No.: 13/283,247

(22) Filed: Oct. 27, 2011

(30) Foreign Application Priority Data
Jul. 9, 2011 (CH) 0118811

(51) Int. Cl. G06F 3/01

(52) U.S. Cl. 715/703

(57) ABSTRACT

In this application, a new system and method to compute and display the changes of the currency strength over time are provided. The new method to compute the currency strength and the visual display overcome limitations and shortcomings of known prior art systems. Thus, a computer system can be provided that is able to compute and display currency strength information in an understandable way to the user that gives much better insight into the development and change of the currency strength over time, showing characteristics of the development of currencies that have not been apparent or discovered before. A user-selectable set of currencies can be displayed, with the strength displayed together in a single region or in separate regions, in a way that is easily understandable and interpretable.

### CROSS-REFERENCE TO RELATED APPLICATIONS

This application claims the benefit, under 35 U.S.C. §119, to Swiss Patent Application No. 01188/11, filed on Jul. 9, 2011, in the Swiss Federal Institute of Intellectual Property, the disclosure of which is incorporated herein in its entirety by reference.

### FIELD OF INTEREST

This invention relates to information visualization, and more particularly, to a method of computing and displaying the changes of currency strengths over time on a computer interface.

### BACKGROUND

Currency exchange rates have a great impact on the economies of the world. Not only are they important for the imports and exports and, therefore, have heavy influence on the economy within a country (e.g., production, unemployment rate, consumer prices, and so on). The foreign exchange market is also the biggest financial market, with trading volumes of about $4 trillion US dollars per day. Having the possibility to convert one currency into another currency is important for business, because otherwise products or services between countries with different currencies cannot be traded. However, most of the trading volume originates from traders on the financial market.

There are millions of participants in this market. Investors, currency speculators, governments, banks, central banks, day-traders, and individual investors, just to name a few, spend countless hours each year analyzing the exchange rates, as they directly influence many financial products. For example, for stocks or funds in a different country with a different currency, the exchange rate directly affects the performance and risk. In addition, it is also possible to buy and sell currencies directly, or to speculate on rising or falling currencies. Furthermore, leveraging products give speculators the possibility to enhance the profit and loss margins. Having insight and understanding of this market, therefore, is essential to many people, as currencies are the interface between many financial products and participants.

Monitoring the exchange rates is a task that is permanently necessary to be successful on the financial market. However, nearly all participants of this market only concentrate on pairs of exchange rates (for example USD/EUR) that are usually displayed with traditional line charts. Of course, it is possible to monitor several different exchange rates with multiple instances of these line charts. However, they only reflect one pair of currencies each. Thus, when trying to monitor the 8 major currencies, for example, 8*7=56 combinations must be observed, which is complicated, and getting an overview of the real happenings and the overall picture or the changes and interrelationships of such currencies is nearly impossible. When all 56 exchange rates are plotted into one line chart simultaneously, the information is nearly impossible to understand, because the high degree of overlap makes it impossible to identify the lines. Solutions to get insight into this market, therefore, are of great help, but they are obviously rare—as most people and institutions still rely on the traditional, but limited, line chart techniques.

Today, many computer programs exist to support the understanding of financial data. Despite using traditional line charts, a lot of new techniques have emerged in financial data analysis, but only very few have been convincing. Additionally, with the advent of the Internet, more and more online brokers and financial websites offer graphical and interactive applications, often with the possibility to trade online. However, regarding the financial market, there is a big demand for solutions, but good solutions that are useful and easy to understand are actually rare. Many solutions can be considered experimental, or too abstract, or with nearly no practical benefit.

The absence of such a practicable solution in the foreign exchange market is evident. On the internet, there are many blogs and discussions, where users relate to one specific exchange rate (for example USD/EUR), and ask questions like: today, the USD got 2% stronger . . . but what is the reason? Is it because the USD got stronger, or is it because the EUR got weaker? It can be very difficult to answer this rather simple question. Even if the exchange rate of USD (United States Dollar) and EUR (Euro) is constant, it may be that both currencies lost strength compared to all other currencies. Thus, analysis of a single exchange rate, for two currencies, may provide no real indication of changes in the individual currencies on a wider scale.

To answer the simple question above, economists, decades ago, developed the so-called currency strength indexes, which can be based on the absolute or the relative currency strength. The associated algorithms are not particularly satisfying. Some algorithms are based on the prices of physical products (“shopping basket”), which shows the buying power of a currency, and is then compared between different countries and currencies. Other algorithms use a fixed starting value (every currency at the beginning has the same strength), and calculate the change of the currency strength over time. However, in this case, it is assumed that all currencies start with the same currency strength value, which is not correct. As a consequence, the whole output or conclusions based on this false assumption are flawed.

One model, the so-called Trade-Weighted-Index, computes the currency strength from the changes of the exchange rates, combined with a weight factor between currencies that comes from the International Monetary Fund (IMF). The disadvantage of this model is that for a start date, this model requires a predetermined starting value. This value significantly influences the rest of the currency index, and also the weights from the International Monetary Fund change from time-to-time, which causes jumps in the computation. For the many participants on the foreign exchange market, the currency strength computed with this model is, therefore, of rather theoretical nature, because in the practical use only the exchange rate counts and therefore this model is not usable. But also from the point of visualization, this model with jumps would not create a satisfying interpretable solution.

Another model is based on so-called nominal effective exchange rates, which is based on the price of material goods in a predetermined shopping basket of products. This model is heavily influenced by other external factors. For example, the price of the same product can significantly differ in compared countries because the manufacturer has different pricing policies for each country. Other factors are taxes, or the location where products are bought in a country, as there are cheap and expensive regions. This model, therefore, completely lacks any mathematical precision.

Another model is the Relative Currency Strength Index, which is computed by a method based on the Relative Strength Index (RSI). This indicator is usually intended to chart the current and historical strength or weakness of the stock market. This method computes separate time series for growth and reduction of a chart, which are smoothened with an exponential moving average. The Relative Strength Index is then computed from a division of the two series. Regarding currencies, this computation needs to be performed for each single pair of currencies. After that, the average of the sum is computed. This model has several disadvantages. This method creates very volatile values, and is only meaningful if rather short time intervals are analyzed because it is heavily data length dependant. The averaging function also causes a large loss of precision, and also the length of the time span over which the average is computed is arbitrary and heavily influences the final result. Therefore, the RSI is not considered a satisfying solution.

In addition to the problems of existing algorithms that have been mentioned, attempts to visually display changes of currency strengths so far can be considered unsuccessful in implementing a system where the data is displayed in a graphically useful manner. Most systems simply plot line graphs into the same chart, which is hardly readable in the end and does not allow a profound analysis.

FIG. 2A illustrates a method for displaying a plurality of currency strength indexes 290, in accordance with the prior art. Each line in FIG. 2 represents a different currency strength, over time. However, such a plot provides little value—it is merely a set of plots displayed at the same time, with no readily ascertainable knowledge of relatedness or relativity between and among the different currency plots.

FIG. 2B gives an overview of seven commercial products available in 2011, showing the current state of the art when analyzing currency strength. Some systems use multiple line charts 292, creating a high degree of over plotting, which is hard to interpret. Other systems only use one line chart 297, which is not able to give an overview and a comparison to other currencies. Other systems use bar charts 293, 295 instead of line charts, but can only show one fixed time interval and are not able to show the changes of the currency strength over time which is not sufficient for understanding the development of the currency strengths over time and to get a more global picture across currencies. The same applies to systems that use numeric values 294, 296, which are also only able to show one fixed time interval, and which are also unable to show the change of the currency strength over time. Other commercial software only shows an up or down arrow for a currency, or a bar that has a certain positive or negative value to show changes of the currency strength.

Getting a real understanding of the behavior and characteristics of all currencies over a period of time is nearly (or completely) impossible with these prior art techniques. Additionally, users today also expect manipulation methods that support exploration of the data, and manipulation of the graphical user interface, which is non-existent in many prior art systems that analyze the currency strength.

### SUMMARY

In this application, a new system and method to compute the changes of the currency strength are provided, which are based on exchange rates, with no external factors or false presumptions. Thus, a computer system can be provided that is able to compute and display currency strength information in an understandable way to the user that gives insight into the development and change of the currency strength over time.

In accordance with the present invention, provided is a software system and computer interface that gives users the possibility to view a quantity of information on an efficiently configured graphical environment.

A financial data interface system according to one embodiment of this invention is configured to operate as financial software application. According to this embodiment, a computer interface system is provided to analyze the changes of currency strengths over time. It divides a display screen of a predetermined size into a plurality of currency strengths, and displays the regions that visualize the strengths of the currencies over a period of time. In one embodiment, this predetermined space is a rectangle. In another embodiment, these display regions that usually form a rectangle are displayed separately to increase readability. These embodiments may work with the method to compute the relative currency strength that is presented in this paper, but may also work with other methods in the same way. In addition to that, the embodiments can also include a menu interface for manipulating and displaying information to the user.

According to the present embodiment, the interface system graphically conveys to the user information about the currency strength over a period of time through the use of display size and color. This way, the user can see the graphical size and color to decipher the changes of the currency strength over time. In one embodiment, the currency strengths are arranged one next to the other, so that the sum of the currency strengths for any point of time t sums up to the same height. In another embodiment, these regions are displayed separately from each other, to increase readability.

It is noted that the computer interface system can be manipulated in various ways to provide functions to the users. These functions can include: changing of the time scale, selecting the currencies which should be displayed, manually or automatically selecting the colors, scaling the display to a different size, using weight functions, zooming in and out, manually or automatically arrange the currencies, highlighting a currency, obtaining additional information for a currency or a point or period of time, enlarging one currency to be exclusively displayed, enlarging two currencies to be exclusively displayed for comparison, using additional graphical or statistical means to show trends, or changing the color for each currency over time for coding additional information. It is understood that these visual parameters may be modified in numerous other ways.

In accordance with one aspect of the present disclosure, provided is a computer-implemented method of presenting changes in strength of currencies over time. The method comprises providing at least one computer processor coupled to at least one non-transitory storage media, and a display; accessing currency exchange rates and electronically computing currency strengths for a plurality of selected currencies for a specified period of time, including computing a currency strength for each of the plurality of selected currencies relative to the other selected currencies; and generating one or more display regions on the display, including presenting within the one or more display regions the currency strengths and relative changes in the currency strengths over time.

The method can further comprise computing said currency strengths as currency strength indexes based on increases and decreases of the currency values over time, such that a sum of the currency strengths indexes for the plurality of currencies is substantially constant over time.

The method can further comprise displaying a plurality of display regions on the display, each display region comprising at least one of the currency strengths, and automatically determining an ordering of the display regions.

The method can further comprise displaying a plurality of display regions on the display, each display region comprising at least one of the currency strengths, and determining an ordering of the display regions in response to a user interaction via a user device.

The method can further comprise displaying additional information about each of said currencies in response to a command provided via a user input device.

The method can further comprise updating said one or more display regions at predetermined time intervals.

Each of said display regions can represent a corresponding currency strength, and a change of size of each display region over time corresponds to the change of said currency strength over time.

The method can further comprise contiguously stacking said currency strengths within the display regions one above the other.

A weakest point of relative currency strengths between at least two different currencies can be 0.

The method can further comprise generating on the display a menu interface having user-interactive mechanisms enabling manipulation and displaying of information related to the plurality of selected currencies.

The method can further comprise generating on the display relevant data for individual regions from the one or more display regions within a pop-up display appearing when one of said regions is selected.

The method can further comprise generating on the display an expanded display providing additional data related to the plurality of selected currencies and user options for interacting with the additional data.

The method can further comprise generating on the display a zoom view of the computed currency strengths.

The method can further comprise re-sizing the currency strengths at predetermined intervals, wherein the re-sizing reflects a change in financial data of the plurality of selected currencies.

The method can further comprise positioning the currency strengths on the display according to a mathematical function employing variables comprising metrics of said currencies.

The method can further comprise providing a user input mechanism to enable a user to modify the time scale of the one or more display regions.

In accordance with another aspect of the present invention, provided is a financial data interface system. The system comprises at least one computer processor coupled to at least one non-transitory storage media, and a display; a financial data processor configured to access currency exchange rates and to compute currency strengths for a plurality of selected currencies for a specified period of time, wherein a currency strength for each of the plurality of currencies is computed relative to the other selected currencies; and output generator configured to generate one or more display regions on the display, wherein the one or more display regions present within the one or more display regions the currency strengths and relative changes in the currency strengths of the plurality of selected currencies over time.

The financial data processor can be configured to compute the currency strengths as currency strength indexes that are computed based on increases and decreases of the currency values over time, such that a sum of the currency strengths indexes for the plurality of currencies is substantially constant over time.

A plurality of display regions can be displayed on the display, each display region comprising at least one of the currency strengths, wherein an ordering of the display regions can be automatically determined.

A plurality of display regions can be displayed on the display, each display region comprising at least one of the currency strengths, wherein an ordering of the currency strengths can be manually determined by user interaction via a user device.

Additional information about each of said currencies can be displayed in response to a command provided to the financial data interface system via the user input device.

The one or more display regions can be updated at predetermined time intervals.

Each of the display regions can represent a corresponding currency strength, and a change of size of each display region over time corresponds to the change of said currency strength over time.

The currency strengths within the display regions can be contiguously stacked one above the other.

A weakest point of relative currency strengths between at least two different currencies can be 0.

The output generator can be further configured to generate on the display a menu interface having user-interactive mechanisms configured to manipulate and display information related to the plurality of selected currencies.

The output generator can be further configured to generate on the display relevant data for individual regions from the one or more display regions within a pop-up display appearing when one of said regions is selected.

The output generator can be further configured to generate on the display an expanded display providing additional data related to the plurality of selected currencies and user options for interacting with the additional data.

The output generator can be further configured to generate on the display a zoom view.

The output generator can be further configured to re-size the currency strengths at predetermined intervals reflecting a change in financial data of the plurality of selected currencies.

The output generator can be further configured to position the currency strengths on the display according to a mathematical function employing variables comprising metrics of said currencies.

The output generator can be further configured to provide a user input mechanism to enable a user to modify the time scale of the one or more display regions.

According to another aspect of the present invention, provided is a computer-implemented method of presenting changes in strength of currencies over time. The method comprises: providing at least one computer processor coupled to at least one non-transitory storage media, and a display; accessing currency values and electronically computing currency strengths for a plurality of currencies for a specified period of time, including computing a currency strength of each of the plurality of selected currencies relative to other selected currencies, including computing said currency strengths as currency strength indexes based on increases and decreases of the currency values over time, such that a sum of the currency strengths indexes for the plurality of currencies is substantially constant over time; and generating one or more display regions on the display, including graphically presenting the computed currency strength indexes for the plurality of selected currencies over time, including graphically presenting relative changes in the currency strength indexes of the plurality of selected currencies over time, including contiguously stacking said currency strength indexes within the display regions one above the other.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention.

In the drawings:

FIG. 1A is a diagram of an embodiment of a network of computer systems that can be used to process and present financial data in accordance with aspects of the present invention;

FIG. 1B is a diagram of an embodiment of a user system that can be configured to provide a graphical user interface for presenting financial data, according to aspects of the invention;

FIG. 1C shows an embodiment of a network accessible financial data interface system as a server-based system, in accordance with aspects of the present invention;

FIG. 1D is a functional block diagram of computer components or modules that can comprise the financial data interface system, according to aspects of the invention;

FIG. 2A illustrates a prior art approach for displaying 8 currency strength indexes over time;

FIG. 2B illustrates seven commercial products available in 2011 for analyzing the currency strength, in accordance with the prior art;

FIG. 3 is a flow diagram of an embodiment of a method used to compute the relative currency strength changes, as a first stage, according to aspects of the invention;

FIG. 4 is a flow diagram of an embodiment of a method for generating a graphical output of currency strengths, as a second stage, according to aspects of the invention;

FIG. 5 illustrates an example of an exchange rate between 2 currencies (USD and EUR), in accordance with aspects of the invention;

FIG. 6A illustrates an embodiment of information used to calculate the currency strength by a fictitious example of 3 currencies according to the flow diagram in FIG. 3, according to one aspect of the invention;

FIG. 6B illustrates an embodiment of information used to calculate and normalize the currency strength by a fictitious example of 3 currencies according to the flow diagram in FIG. 4, according to one aspect of the invention;

FIG. 7 illustrates an embodiment of a graphical user interface output that shows changes of the relative currency strength over time for three currencies (USD, JPY, EUR), according to one aspect of the invention;

FIG. 8 illustrates an embodiment of a graphical user interface output that shows changes of the relative currency strength over time for seven currencies, according to aspects of the invention;

FIG. 9 illustrates another embodiment of a graphical user interface output for seven currencies in a separated arrangement, according to aspects of the invention;

FIG. 10 illustrates another embodiment of a graphical user interface output for ten currencies, according to aspects of this invention;

FIG. 11 illustrates a graphical user interface output according to FIG. 8, wherein one portion is enlarged by a zoom, according to aspects of the invention;

FIG. 12 illustrates another embodiment of a graphical user interface output using a linear function, according to another aspect of the invention;

FIG. 13 illustrates an embodiment of a graphical user interface output including a legend control, according to an aspect of the invention;

FIG. 14 illustrates an embodiment of a graphical user interface output including an information display, according to aspects of the invention; and

FIG. 15 illustrates another embodiment of a graphical user interface output for seven currencies, without normalization of the weakest point of a currency to a value of 0.

### DETAILED DESCRIPTION

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

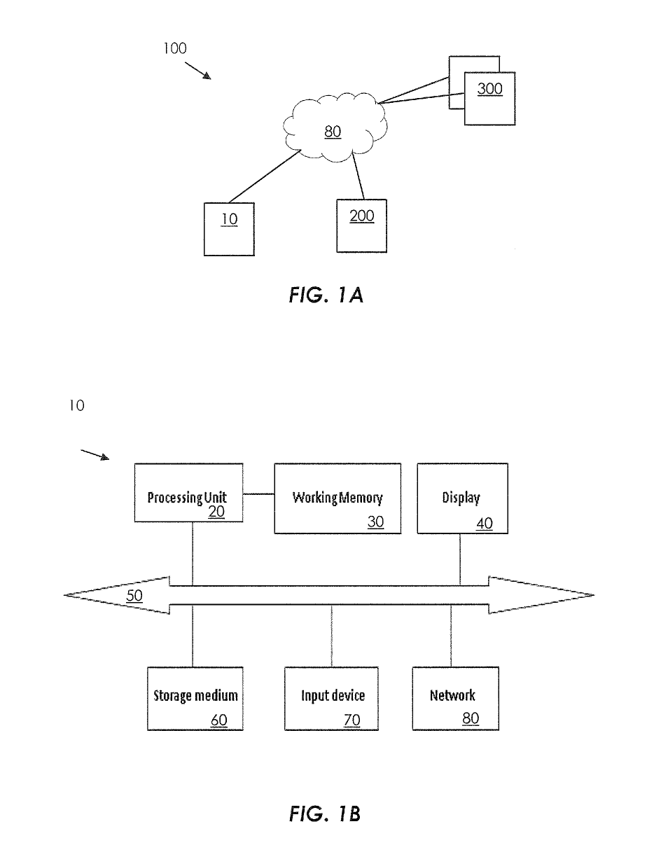

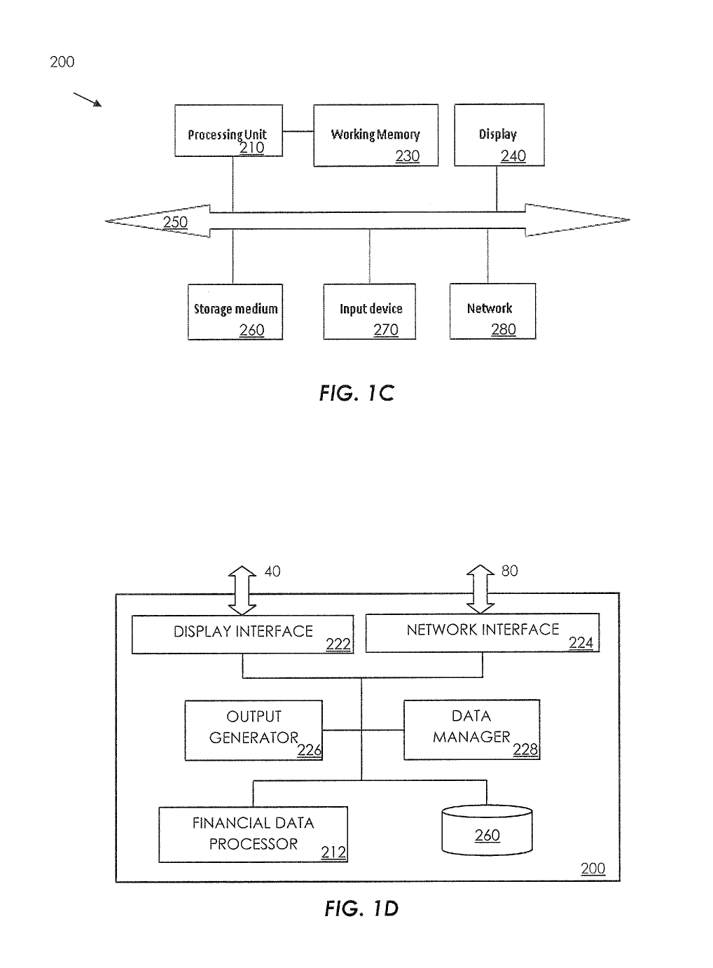

FIG. 1A is a diagram of an embodiment of a network of computer systems 100 that can be used to process and present financial data in accordance with aspects of the present invention. A financial data interface system 200 may be provided to include the hardware, software, and/or firmware that enable financial data processing and presentation in accordance with aspects of the present invention. The financial data interface system 200 may be a properly configured computer system having at least one processor, at least one data storage device, and input and output devices.

The financial data interface system 200 may be network enabled or accessible, and communicate via at least one network 80. As examples, network 80 may be the Internet, Worldwide Web, a local area network, a wide area network, a virtual private network, a cellular telephone network, a cable network, a satellite network, or the like, or some combination thereof.

The financial data interface system 200 may receive financial data, e.g., currency data, from one or more financial data sources 300, via network 80. The data from financial data sources 300 may be pushed to or pulled by the financial data interface system 200. Such financial data sources 300 may be, for example, government entities or private entities that report currency and/or exchange rate information or other relevant financial or economic data or information.

The financial data interface system 200 may be, or may be part of, an end user system, having input and output devices, such as display screens. In other embodiments, the financial data interface system 200 may be a server or application server accessible by a user system 10. In such cases, the user system 10 can include a program useful for interacting with the financial data interface system 200 to output and interact with displays including financial analysis or comparative data and information. In some embodiments, that program could be or include a Web browser, word processor, spreadsheet, database, or other program, or combination thereof.

FIG. 1B is a diagram of an embodiment of a user system 10 that can be configured to provide a graphical user interface for presenting financial data, according to aspects of the invention. User system 10, which is a computer system or user device, can be configured to enable access and use of the financial data interface system 200. User system 10, which can be used as terminal, can include components such as a CPU 20, working memory 30, storage medium 60, and/or other hardware. Furthermore, user system 10 can comprise a display screen 40 for visual or graphical output to the user of financial analysis data and information from the financial data interface system 200. Also provided can be input devices 70 that allow human-computer interaction. These various devices, components, or modules of user system 10 can be coupled together via a bus 50. It is understood that the components of user system 10 may be modified in numerous ways, without departing from the invention. User system 10 may be, or include, a personal computer, workstation, laptop computer, cell phone or smart phone, network-enabled tablet or personal digital assistance, and the like, as examples.

Today, various systems get financial data from the Internet and/or various network-accessible sources. In one embodiment, user system 10 is configured to implement the financial data interface system 200. In other embodiments, the interface system 200 can be implemented on or across multiple systems.

FIG. 1C shows an embodiment of a network accessible financial data interface system 200 as a server-based system, in accordance with aspects of the present invention. In this example, as a networked system, financial data interface system 200 may be configured to interact with a plurality of user systems 10 and financial data sources over network 80, as discussed above with respect to FIG. 1A. Each user system 10 interacts with the financial data interface system 200 over network connection 80, such as the Internet, for example to load or to update data.

The financial data interface system 200 servers can include components similar to those of the user system 10. For example, these can include a CPU 210, working memory 230, storage memory 260, network interface 280. However, financial data interface system 200 server is not required to have all of these components to do the required task. Therefore, FIG. 1C only depicts a typical illustration of a server. The server may or may not include at least one display 240 and a bus 250 for internal communication. Similarly, the server may or may not include at least one input device. It is understood, that the components of the financial data interface system 200 server may be modified in numerous ways.

Referring to FIG. 1D, the financial data interface system 200 can include various functional modules, which can be implemented in hardware, software, firmware, or some combination thereof. In this embodiment, the financial data interface system 200 can include the storage media 260 discussed above, or an equivalent. A display interface 222 can be provided to drive display devices, and provide displays in accordance with the present invention, as described herein below. A network interface 224 can be provided that enables communication between the financial data interface system 200 and financial data sources 300, user systems 10, or other systems, via network 80.

A data manager 228 can be provided to obtain, request, store, and/or access financial data information. An output generator 226 can be provided that obtains financial data and display information, e.g., display templates or instructions stored in storage media 260, which are ultimately output to a display via display interface 222. A financial data processor 212 executes the financial data analysis and processing algorithms used to generate the financial data displays output in accordance with the present invention.

It is understood that the financial data interlace system 200 may be implemented with different or additional components that could provide extra functionality to the application and system.

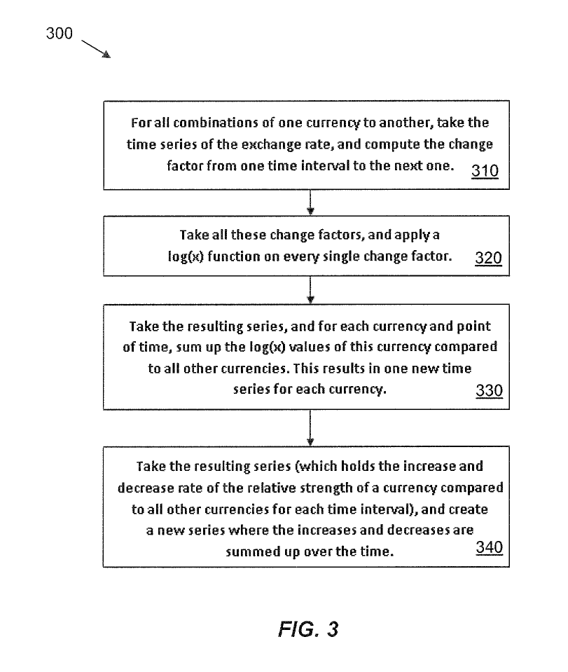

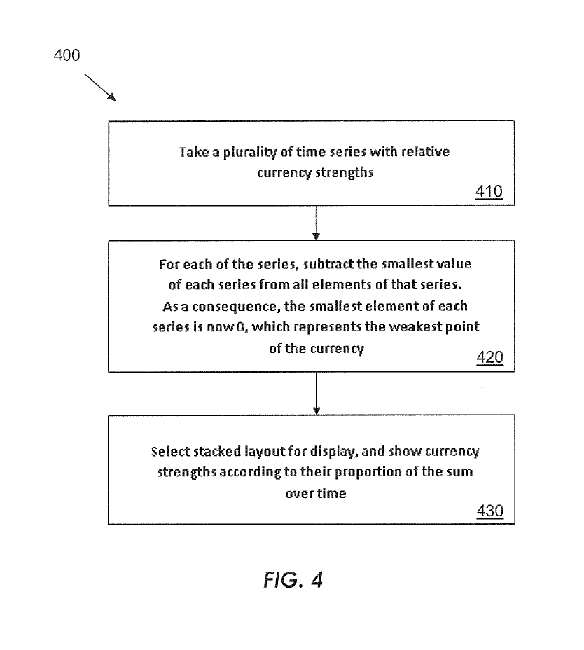

The financial data interface system 200 can be configured to implement a method of financial data analysis and display in accordance with aspects of the present invention. FIG. 3 is a flow diagram of an embodiment of a method used to compute the relative currency strength changes, in accordance with aspects of the invention. And FIG. 4 is a flow diagram of an embodiment of a method that illustrates how a second stage takes a time series with relative currency strengths, and generates a graphical output, according to aspects of the invention. These methods can be implemented, as an example by the above described computer systems.

The process or method by which the financial data interface system 200 generates the graphical outputs is now explained in more detail. The method of this embodiment operates in two stages: computing the currency strength for a plurality of currencies with a unique method, and positioning the result of this computation on the display by exploiting the special characteristics of the method in the first stage. As a preliminary, the underlying objectives of these methods are briefly detailed.

As existing methods of calculating the currency strength according to previous art have serious weaknesses (see overview of prior art methods before), a novel method of computing the currency strength is proposed. In addition to that, prior art systems use very simple graphical representations to display the result of that computation (such as line graphs, bar charts, arrows, or numbers). This, however, is not a satisfying solution, and therefore a better visualization method to display the changes in currency strengths is proposed that perfectly matches the special characteristics of the novel method, in the preferred embodiment.

The foreign exchange market is considerable different to other financial markets, such as the stock market. As stocks or funds can be examined separately, currency analysis only makes sense if currencies are analyzed as a currency pair, which means that a currency is compared to another currency over time. However, analyzing a single pair might give insight into the relationship between these two currencies, but is to some degree useless if not put into a bigger context. Regarding all currencies of the world, a lot of these currency pairs exist. But when analyzing several of these currency pairs, the overall behavior of the market still remains a secret. Therefore, analysts are missing the “big picture”.

One interesting characteristic of the foreign exchange market is that certain parity can be observed. Although this market is permanently in motion, with exchange rates between currencies updating within seconds, some rules can be observed and exploited. The reason for this high degree of parity is that today there are many trading systems that trigger in milliseconds to make minimal profits, and which cause the exchange rates to re-adjust within shortest time frames. Therefore, the exchange rates between multiple currencies are in some sort of “stable” state, and increases and decreases of one currency automatically affect not only the other currencies that are directly connected to it, but also the exchange rates of other currencies among themselves.

The methods described below in this application are based completely on the exchange rates (transaction costs are not considered), and exploit this high degree of parity that this market has. However, as the exchange rates in the market undergo constant changes and fluctuations, parity is existent to a very high degree, but not mathematically perfect. There are minimal deviations all the time, which prior art algorithms that use the exchange rates as well as the presented invention have to cope with. It is understood that the methods described in this application are formulated to be mathematically correct, but in practical use always include these minimal deviations. However, the method described below is designed to automatically compensate these minimal deviations when the graphical output is created.

When doing a trade with a currency pair, for example USD/EUR, it is easy to see that if an amount of 1 EUR is exchanged to USD and then it is changed back from USD to EUR, roughly the same initial amount of 1 EUR will occur. The differences are only minimal, usually something in the area of 3 to 4 digits after the comma. We can therefore say that the exchange rate in one direction is roughly 1/x of the exchange rate in reverse direction. As an example, if 1 EUR is traded to USD on Jan. 1, 2006 with the official rate, the trader will get 1.18396 USD. If the same amount is traded back to EUR on the same day with the official rate, the trader will get 0.99983 Euro, which is the initial value, with only a minimal deviation of 0.017%, or 0.00017 Euro. Vice versa, if the amount of 1 USD is traded to EUR on Jan. 1, 2006 with the official rate, the trader will get 0.84448 Euro, and when trading back the amount to USD, the trader will end up with 0.99983 USD. The trader, in both cases, will have a minus of 0.017%.

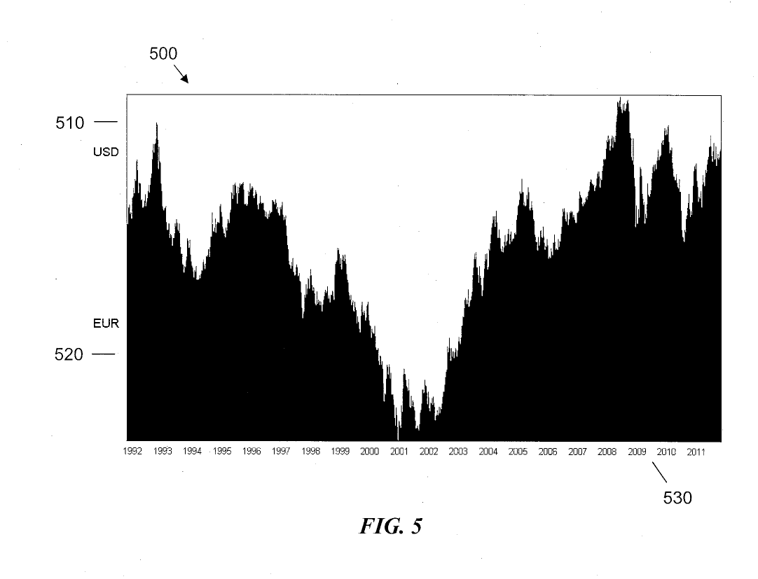

Regarding this example of the exchange rate of USD and EUR over time in a closed system of only 2 currencies, the changes over time can also be interpreted as the changes of the currency strength between USD and EUR. If the exchange rate of USD and EUR is drawn as a line chart (as can be seen in FIG. 5), the relative strength is reflected by the display regions above and below the line. In addition to that, typical to a line chart, the time axis and the value span a rectangular space. Therefore, the regions above and below the line that are surrounded by the rectangle, fill a display space that reflects the changes of the currency strength over time where it is easy to identify the strongest and weakest point as well as the strong and weak phases of a currency strength.

The reason for this is that for an amount of 1 EUR at any given point of time t, there will be a certain amount of USD to get in return. If this amount of USD is traded back to EUR at the same point of time t, the initial amount of 1 EUR with only minimal deviation will occur. So the exchange rate x and the reverse exchange rate 1/x causes that the sequence of the two trades x*(1/x) is just a multiplication by 1, which means that for any given initial amount that is traded in forth and back direction, the result is the starting amount with minimal deviation. The exchange rates of EUR/USD and for USD/EUR therefore complement themselves to an almost constant value, and the display regions are able to fill a rectangular space (see FIG. 5).

In accordance with the present invention, provided is an algorithm and a graphical display to extend this rationale to three or more currencies, and to display this plurality of currency strengths in a rectangular space with the changes of the currency strength over time. As a second example with three currencies, if the amount of 1 EUR is traded to USD on Jan. 1, 2006 (see example above), an amount of 1.18396 USD will be received in return. For the amount of 1.18396 USD, on the same day one would get 139.30 JPY (Japanese Yen). If the amount of 139.30 JPY is traded back to EUR, then 0.99970 Euro will be received, which is the initial amount with only a minimal deviation at the 4th digit after the comma. As a second example, 1 EUR that is traded on Jan. 1, 2011, will result in 1.33393 USD, which can be traded to 108.52 JPY (Japanese YEN), which results in 0.99957 EUR. As can be observed, the parity of the foreign exchange market is highly precise not only in pairs, but accordingly if a sequence of pairs is taken.

So when extending the idea to three currencies, we can again perceive that this sequence produces a result that is nearly 100% of the initial value. The reason behind this is very simple, and it was already referred to before. Would it be possible to have a 102% value when trading inside a circle of three currencies, one could just repeat this sequence, and each time could generate a 2% profit. Vice versa, as the exchange rates in opposite direction are 1/x of the exchange rates, one would only get 98% of the initial value back if trading in the circle in the opposite direction. The thousands of fast computer systems today that automatically use the small margins to make minimal profits within milliseconds would even out this situation to create a parity again, because the value of the currency that causes this situation would be evened out within short time. Commonly, the result of such a trading sequence is around 0.01% less than 100% when using the official exchange rates.

As the trading of an initial amount of money between three currencies as described above nearly produces the same initial amount again, is it also possible to reflect this in a rectangular shape, with the time t on one axis and the initial amount of 100% of the money on the other axis. Because the result of the trading sequence is constant, it is possible to reflect the changes of the currency strength over time within a rectangular outline with three currencies as well. However, as the exchange rates between the three currencies change over time, these changes also need to be reflected correctly inside the rectangle over time, in a way that the change of the currency strength can be depicted. Another requirement of the algorithm is that the result is always the same, no matter in which order the trading sequence takes place (EUR->USD->JPY->EUR, USD->EUR->JPY->USD, JPY->USD->EUR->JPY, just to mention a few of the possible combinations).

What can easily be observed by the given two examples of trading EUR->USD->JPY-EUR is that the increase in strength of one currency in an exchange rate requires a decrease of the strength of other currencies in other exchange rates, so that trading an amount in this sequence leads to the same initial amount again. Therefore, there is parity not only between two exchange rates, but also between three, four, and so on. As there is parity, the increase and decrease of the exchange rates between the currencies in these pluralities of currencies exactly even out.

Two Stage Algorithm—Introduction

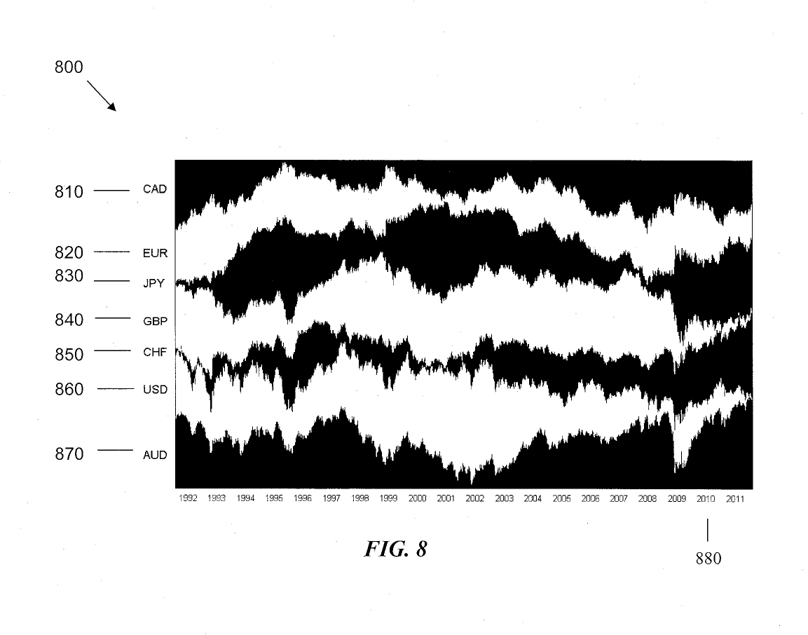

The process or method by which the financial data interface system 200 generates the appropriate regions for display on a computer interface is explained. References are made to FIGS. 3, 4, 6A, and 6B, which illustrate a calculation scheme for the algorithm and flow diagrams of the different steps to generate a graphical representation, according to one embodiment of the present invention. The method of this embodiment operates via two stages, a first stage 300 depicted in FIG. 3 and a second stage 400 depicted in FIG. 4. The computation of the currency strength indexes is performed in the first stage, according to steps 310-340. And the normalization and positioning of the currency strength series from the first stage on the display is performed in the second stage, according to steps 410-430. For each of the views discussed in reference with FIGS. 8-10, the system performs both stages respectively.

The methods described below in this application are based completely on the exchange rates, and exploit the high degree of parity in this particular market explained in the previous section.

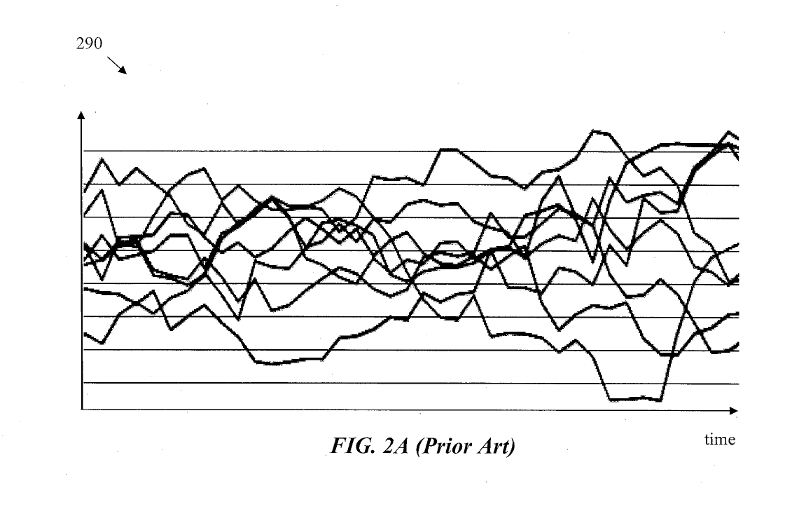

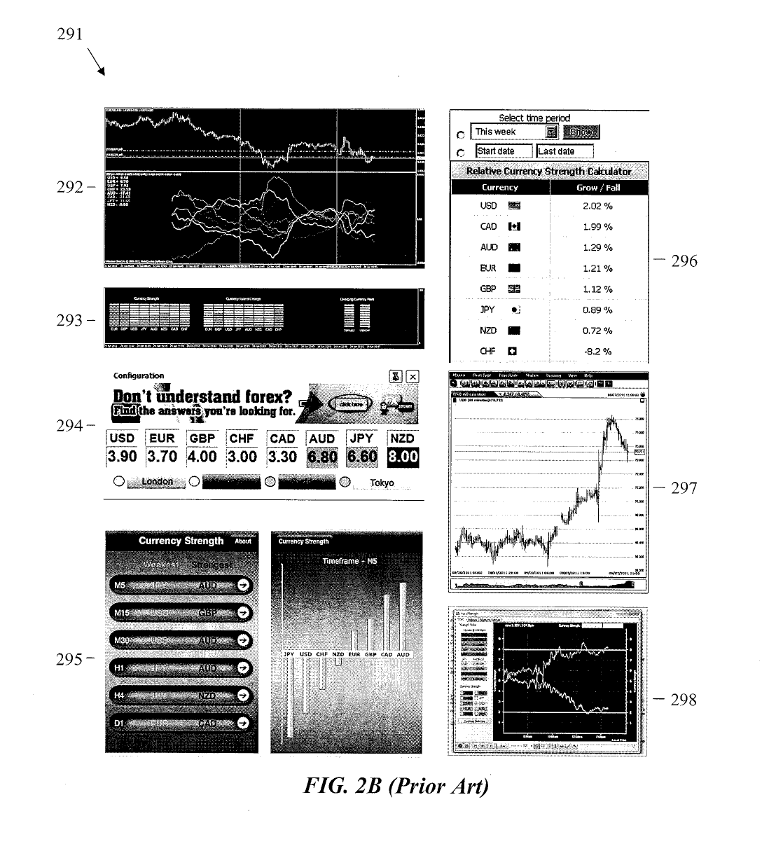

As a preliminary, the underlying objectives of this method are briefly detailed. Getting a real insight into the strengths of currencies on the foreign exchange market (Forex) is very difficult, as currencies are commonly traded as pairs. To get the big picture, for example, regarding the ten major currencies of the world, a combination of 10*9=90 currency pairs has to be taken into account to give profound and meaningful answers. Manual analysis of 90 line charts simultaneously is a tedious task (e.g., see FIG. 2A with 8 currencies), and it can be assumed that the result of the analysis is neither reliable nor precise. Economists have developed instruments, which show how the relative strengths of currencies can be computed. As described in the Background section herein, existing techniques have serious disadvantages. Examples are fixed starting values where the strength of all currencies is equaled (which is not the case), shopping baskets where many other factors influence the product price, or methods where increases and decreases of the currency strength do not directly correspond to each other in the same degree, just to name a few.

Therefore, the use of a computer-implemented algorithm that computes the changes of the currency strength over a period of time that is purely based on exchange rates, without the known disadvantages is the most promising solution. Additionally, if the sum of the increases of the strengths of currencies exactly matches the sum of decreases of the strengths of other currencies, it is possible to visualize the changes of the currency strength in a closed system of a plurality of currencies in a way that the sum of the currency strengths for any given point of time (t) is constant (with minimal deviations), exploiting the above mentioned parity of exchange rates for a given amount of currencies. Therefore, for example, a predetermined geometric display space, such as a rectangle, can perfectly be used to display the changes of the currency strength over time, as the time axis and the constant sum of values of the currency strengths for each point of the time axis create a rectangular shape, according to the present embodiment.

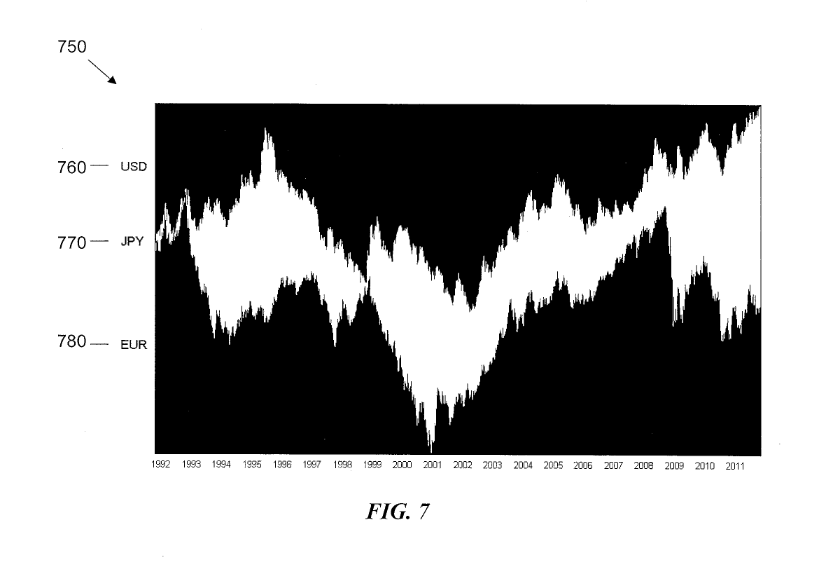

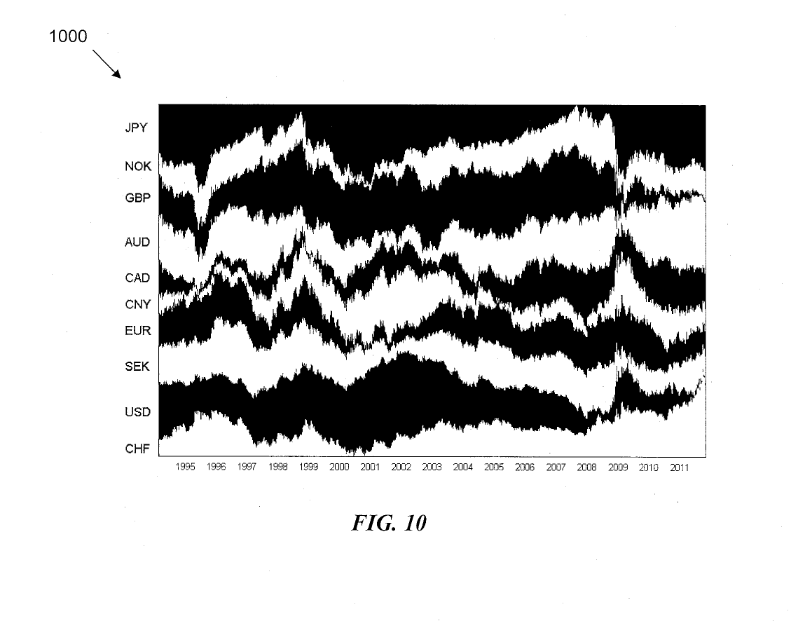

Given a rectangular space, such as the display area of a display screen 40, or a portion thereof, and a plurality of display regions, such as currency strengths 760-780 of three currencies shown in FIG. 7, the financial data interface system 200 is initiated with the aim of dividing the display area into regions that reflect the strength of currencies over a period of time t. FIG. 8 shows a similar display for the 7 major currencies, FIG. 10 shows a similar display for the 10 major currencies.

Stage 1 (Computation of Currency Strength)

The method 300 to compute the currency strength in one embodiment of the presented invention works as illustrated in the flow diagram in FIG. 3. However, in another embodiment, the instructions that are processed may also be executed in a different order with the same result, as the ordering of some mathematical functions that are used here can be swapped. For example, the order of factors that are multiplied or divided, or numbers that are added or subtracted one to each other, can be swapped with no difference of the final result. It is understood that the changes of ordering of certain operations does not affect the final result, while effectively doing the same thing. Therefore, FIG. 3 is only to be seen as a means to facilitate understanding the underlying principle of the method.

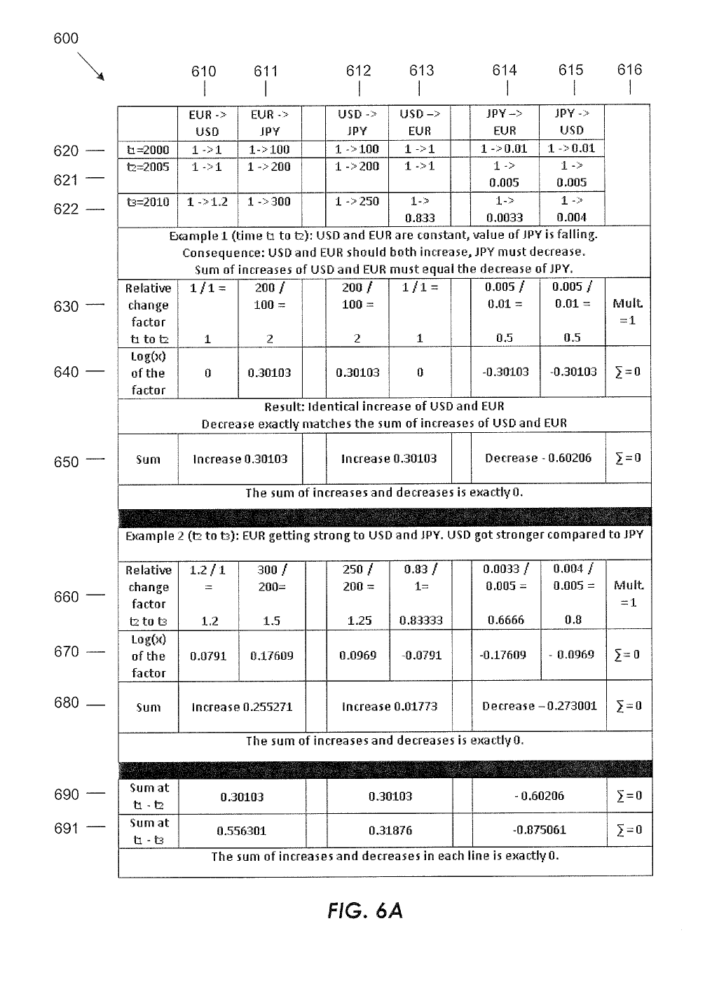

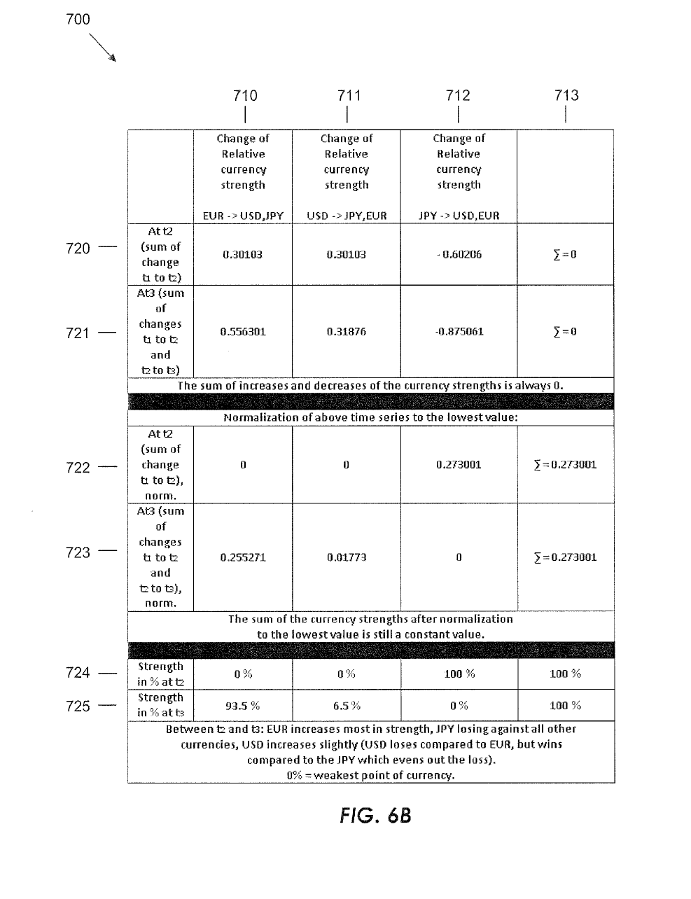

FIG. 7 shows a display for 3 currencies that can be produced by method 300, with the method as shown in FIG. 6A. FIG. 8 shows a display for the 10 leading currencies using method 300.

Given a plurality of currencies, the first stage method 300 of the financial data interface system 200, as a first step 310, computes the relative change factor of the exchange rate from one currency to another currency for one point of time t1 to the next point of time t2, in step 310, which is a time interval between t1 and t2. This is done for the whole time series (=all consecutive time intervals), and for all combinations of currencies (=all possible exchange rates).

Referring as well to the exemplary three currency example in FIG. 6A, to facilitate understanding of this method, the financial data interface system 200 computes the change factor from the currency pair, still in step 310, EUR->USD in column 610 between the year 2000 in row 620 and the year 2005 in row 621. As the exchange rate in the year 2000 (shown in row 620) was 1:1 (depicted as 1->1), and in the year 2005 (shown in row 621) it was also 1:1, the relative change factor is “1” (shown in row 630), which means a multiplication by 1, and therefore no change. This can also be done accordingly from EUR to all other currencies between point of time t1 and t2.

In this example with three currencies, each currency is compared to 2 other currencies. Therefore, besides EUR->USD in column 610, the EUR also needs to be compared to the JPY (EUR->JPY in column 611). As the exchange rate EUR->JPY in column 611 in the year 2000 was 1:100 shown in row 620, and the exchange rate EUR->JPY in year 2005 was 1:200 (shown in row 621), the relative change factor is 200/100=2 (shown in row 630), which means that for 1 EUR, one would get twice as much JPY in return at point of time t2 than at t1. Accordingly, this also needs to be calculated for the other currencies. The result of this step can be seen in FIG. 6A in the corresponding row 630. If all factors in row 630 are multiplied by each other, the result is 1 (see column 616).

In the second step 320 of the algorithm, a logarithmic function is applied to the elements that were computed in the first step 310. In the example in FIG. 6A, for EUR->JPY in column 611, in the first step, we computed a relative change factor of 2 between year 2000 in row 620 and year 2005 in row 621. In addition to that, we also computed the relative change factor for the reverse exchange rate, which is JPY->EUR in column 614 between year 2000 row 620 and year 2005 row 621, the result was 0.5. Regarding the pair EUR and JPY, as the increase in strength of the EUR over JPY must exactly equal the decrease in strength of the JPY compared to the EUR, we apply a logarithmic function on the mentioned relative change factors. For EUR->JPY in column 611, the relative change rate row 630 was 2, and log (2) is 0.30103 in row 640. Correspondingly, for JPY->EUR in column 614, the relative change rate row 630 was 0.5, and log(0.5) is −0.30103 in row 640. As can be perceived, the absolute value of the increase of the EUR->JPY matches exactly the absolute value of the decrease of JPY->EUR. Therefore, the increase and the decrease exactly level out. Correspondingly, as all factors in row 630 multiplied in the first step results in step 310 turned out to be 1 (see column 616), now the sum of all increases and decreases in row 640 in the second step 320 is 0 (see column 616). Therefore, the changes after step 320 in the relative currency strength even themselves out if they are summed up.

In the third step 330 of the method 300, the values that were computed in the second step 320 of the algorithm are summed up for each currency compared to the other currencies for each point of time t. More generally, if “m” currencies are compared, m−1 values need to be summed up for each currency and point of time t. In the example in FIG. 6A, three currencies are compared, so for each of the three currencies the values from step 320 for the two other currencies need to be summed up. As the EUR->USD in column 610 had a value of 0 in row 640, and the EUR->JPY in column 611 had a value of 0.30103 640, the sum for the EUR compared to the other two currencies is 0+0.30103=0.30103 650. The sum for the USD is 0.30103+0=0.30103 in row 650, and the sum for the JPY is −0.30103+−0.30103=−0.60206 650. Consequently, the sum of all the values in row 650 is again 0, as it was before in the second step 320 of the method 300, because the corresponding pairs in row 640 had a sum of 0. The values in these time series for each currency are the increases and decreases in currency strength of said currency for each time interval.

In the fourth step 340 of the method 300, these changes (increases and decreases) of the currency strength that have been computed with steps 310-330 for each currency and for each time interval, are accumulated over time. In our example in FIG. 6A, the result of the third step 330 of the method 300 for the EUR in columns 610-611 for the time interval between year 2000 in row 620 and year 2005 in row 621 was 0.30103 in row 650, and for the second time interval between year 2005 in row 621 and year 2010 in row 622 it was 0.255271 680. If accumulated, the value for the first time interval t1 to t2 is 0.30103 in rows 650 and 690, and the value for the second time interval t2 to t3 is 0.30103 in row 650+0.255271 in row 680=0.556301 in row 691.

Correspondingly, for the USD in columns 612-613, the accumulated changes over time are 0.30103 in rows 650 and 690 for the first time interval t1 to t2, and 0.30103 in row 650+0.01773 in row 680=0.31876 in row 691 for the second time interval t2 to t3. For the JPY in rows 614-615, the accumulated series over time is −0.60206 in row 650 for the first time interval t1 to t2 in row 690, and −0.60206 in row 650 +(−0.273001) in row 680=−0.875061 in row 691. This method is applied on the full length of the time series. At each point of time t, the sum of the currency strengths is 0 (see column 616), therefore increases and decreases of the currency strengths exactly complement each other. This computation of the currency strengths over time in steps 310-340 concludes the first stage 300 method, in this embodiment.

Variations for Stage 1

1) 1^{st} Variation of the Method 300

In one embodiment, as a variation of the method step 320, the method uses a linear function instead of a logarithmic function, which has the advantage that the scale of the increases and decreases regarding their magnitude is preserved, without the typical logarithmic side effects. For example, the financial data interface system 200 computes the weight of the increase rate in percent over the decrease rate in percent, and uses an averaging function to modify the increase and decrease rate. In the example in FIG. 6A, regarding the currency pair EUR->JPY in column 611 from year 2000 in row 620 to year 2005 in row 621, the EUR->JPY in column 611 increases by a factor of 100% in row 630, and the JPY->EUR in column 614 decreases by a factor of −50% 630. Therefore, according to this embodiment, as the absolute value of the increase rate (+100% in row 630) is twice as large as the absolute value of the decrease rate (−50% in row 630), the increase rate is cut by ⅔, and the decrease rate is raised by ⅓. As a result, the increase rate is now set to +33%, and the decrease rate is set to −33%.

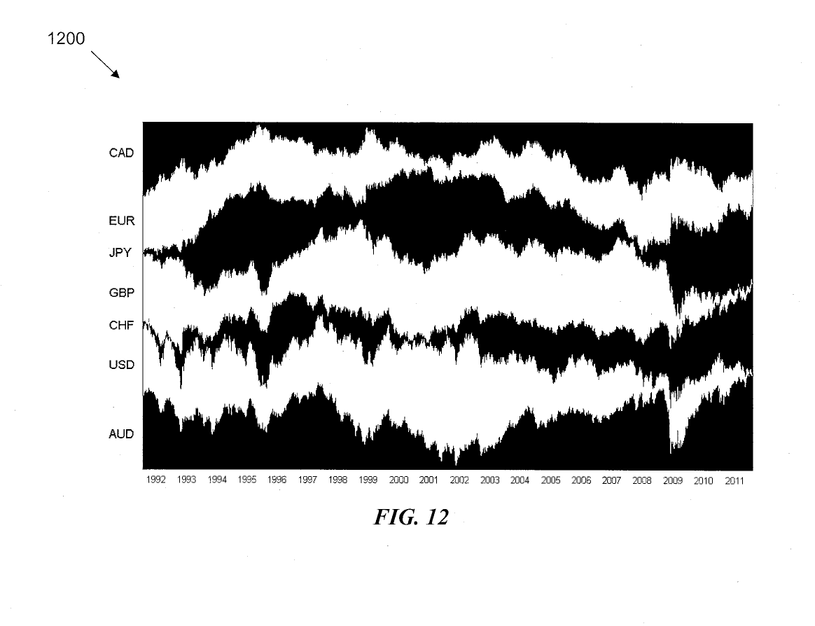

FIG. 12 illustrates the result of such a modification according to this alternative embodiment, which is similar to the display of FIG. 8, generated using the unaltered method 300 of FIG. 3. The difference of the currency strengths at the last point of time is only 0 to 2 pixels, regarding a height of the image of 500 pixels. It is understood that a large variety of similar modifications can be constructed that can be used to modify the method 300, but effectively doing the same thing with a similar result.

2) 2^{nd} Variation of the Method 300

In another embodiment of the present invention, a weighting factor can be assigned to each currency, so that, for example, major currencies have larger impact on the result than smaller currencies. In another embodiment of the present invention, also other parameters can be used to influence the weight, for example a multiplication with any other value (weighting factor, importance factor, or any other value), or to vary the base method steps 310-340.

Stage 2 (Computation for Positioning of Currency Strengths on the Display)

The second stage 400, the normalization and positioning of currency strengths series on the display, is employed so that the currency strengths series can be arranged or positioned in their proper locations. It is noted that there is more than one “proper” location, as the positioning of this stage is not limited to any one specific method. For example, the ordering of the currencies can be altered. Basically, the method of stage two is primarily configured to create a visually appealing appearance, and to facilitate the analysis of the development of the currency strengths over time. Thus, the method of the second stage may be used to arrange the regions by a mathematical function of various characteristics of displayed regions, such as for example, the size or shape of a region, etc. Accordingly, the optimization arrangement provides a further enhancement to the graphical view since the user may analyze the data in a more effective and easier way.

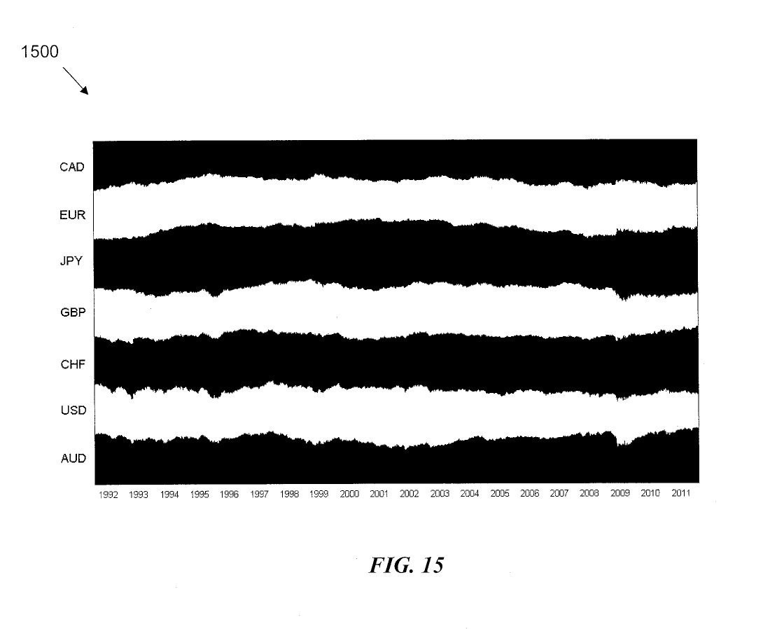

In a first step, a plurality of currency strength time series is required, in step 410. In the preferred embodiment, the currency strength time series are computed with the method described in stage 1, in steps 310-340. In accordance with the present embodiment, the special way in which the currency strength is computed with the method described above already ensures that the sum of the currency strengths for a plurality of currencies is 0 at all points of time, and that it is possible to display the currency strength in a rectangular shape, as illustrated in the plot 1500 of FIG. 15.

In a second step 420, the currency strength time series 720-721 are normalized. The fictitious example in FIG. 6B may help to understand this process. The smallest value of each series is subtracted from all elements of that series 722-723. As a consequence, the smallest element of each currency strength time series is now 0, which represents the weakest point of the currency compared to the other currencies for the given period of time 722-723.

As the sum of the currency strengths according to our method was a constant 0 for all points of time in rows 690-691 and 720-721, adding a constant value x to this 0 will create a constant value again. The value x is of the sum of the smallest elements of the currency strength time series. In the example in FIG. 6B, the normalized time series for EUR would be transformed from (0.30103, 0.556301) in rows 720 and 721 to (0, 0.255271) in rows 722 and 723, the normalized time series for USD would be transformed from (0.30103, 0.31876) in rows 720 and 721 to (0, 0.01773) in rows 722 and 723, and the normalized time series for JPY would be transformed from (−0.60206, −0.875061) in rows 720 and 721 to (0.273001, 0) in rows 722 and 723. The 0 represents the weakest point of time of a currency. In the example in FIG. 6B, the sum of the values for each point of time t after the normalization is 0.273001 in rows 722 and 723 in column 713, which reflects the sum of the negative minimum values of the currency strengths time series before the normalization ((−0.30103)+(−0.30103)+(+0.875061)=0.273001). As the sum, as a result, is constant again, it is ensured that the normalization step preserves the special property of the first stage method, and the currency strength time series still form a rectangular shape after this normalization.

In the third step 430, the layout to be displayed is computed. As the normalized currency strengths in the previous step 420 sum up to a constant value of x at each point of time t, it is possible to determine the proportional amount that each currency strength has at point of time t compared to this constant sum. The proportional amounts in percent add up to 100% as shown in rows 724 and 725 and column 713, therefore, in the preferred embodiment, it is possible to form a rectangular shape, with time t on the one axis, and the proportional amounts of the currencies that add up to a constant value on the other axis.

The method to generate this stacked graph is that at each point of time t, a display region corresponding to the proportion of the currency strength with regard to the sum is plotted, one above the other. As the sum of the currency strengths is constant, in the stacked graph they also add to the same value and therefore to a constant height. The deviations and rounding errors are eliminated in this step, as the sum of the values (which should be constant, but effectively there are minimal deviations) is re-computed for each point of time t before determining the proportional amount of a currency strength compared to this sum.

FIG. 5 illustrates the visual appearance in the preferred embodiment of the invention for 2 currencies. FIG. 7 illustrates the visual appearance in the preferred embodiment of the invention for 3 currencies. FIG. 8 illustrates the visual appearance in the preferred embodiment of the invention for 7 currencies. And FIG. 10 illustrates the visual appearance in the preferred embodiment of the invention for 10 currencies.

Variations for Stage 2, Separated View

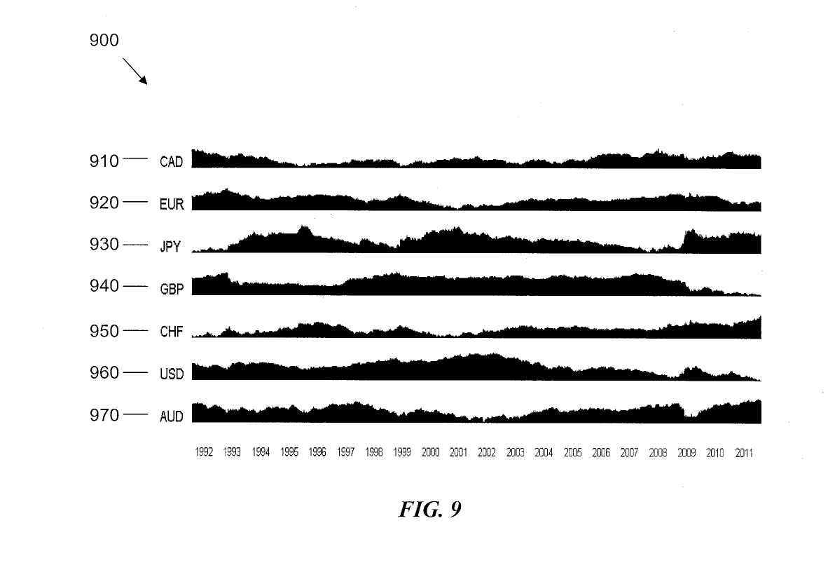

In one embodiment of the invention, the financial data interface system 200 shows the currency strength time series not in a stacked view as in, for example FIG. 8, but in a separated view as in FIG. 9 in order to facilitate analysis of the currency strength. FIG. 9 is a display of the seven currencies shown in FIG. 8 as separate currency strength time series plots over time. As the bottom of the display space for each currency strength is a line or axis that makes it is easy to determine the currency strength by reading the height of the display space, relative changes can be visually determined in a quick, user-friendly manner. This makes it a lot easier for the user to determine the phases where a currency was strong or weak. In another embodiment of the invention, half of the height is mapped above and half of the height is mapped below the axis line.

Automatic or Manual Arrangement

In one embodiment of the invention, the ordering of the currencies for display can be manually arranged by user interaction with the financial data interface system 200. In another embodiment of the invention, the ordering of the currencies for output can be automatic, for example, depending on some mathematical function implemented automatically by the financial data interface system 200.

Preferably, the ordering of the currencies for display is arranged in a way that increases a good appearance of the currency strength, depending on the shape of the display regions as shown for example for the currencies in FIG. 10. In FIG. 10, 10 currency strengths are shown, over time. For this display a user, such as an entity involved in the trading of currencies, can easily see the different currency strength of each currency as the same time, and relative trends.

One strategy to create a visually more appealing appearance is to arrange the ordering of the currencies in a way where strong and weak phases of currencies even themselves out in a way that the pathways of currencies are as horizontal as possible. Another strategy to create a visually more appealing appearance is to arrange the ordering of the currencies in a way that as few breaks of the pathways occur, which can happen, depending on the order. This method provides for a more appealing visual display by not randomly plotting the regions. It is understood that there are many other aspects that can also be considered to improve the ordering of the currencies, and correspondingly there is a large variety of mathematical function to achieve that.

Embodiment of various displays will now be explained, which can be generated and presented in a computer by the financial data interface system 200, and in accordance with associated methods thereof.

FIG. 8 illustrates a view of the screen on display 40, as an example, as generated by the financial data interface system 200, according to the preferred embodiment of the present invention. In accordance with this embodiment of the present invention, the financial data interface system 200 divides the available screen on display 40 into a plurality of display sectors 810-870 corresponding to the currency strength time series over a period of time for different currencies. In this embodiment, these are contiguously stacked to fill a predetermined space. In the example in FIG. 8, the currencies are CAD 810, EUR 820, JPY 830, GBP 840, CHF 850, USD 860, and AUD 870. The system is, however, not limited to these 7 currencies, and can work with any amount of currencies, as shown in other display screens provided herein, as further examples.

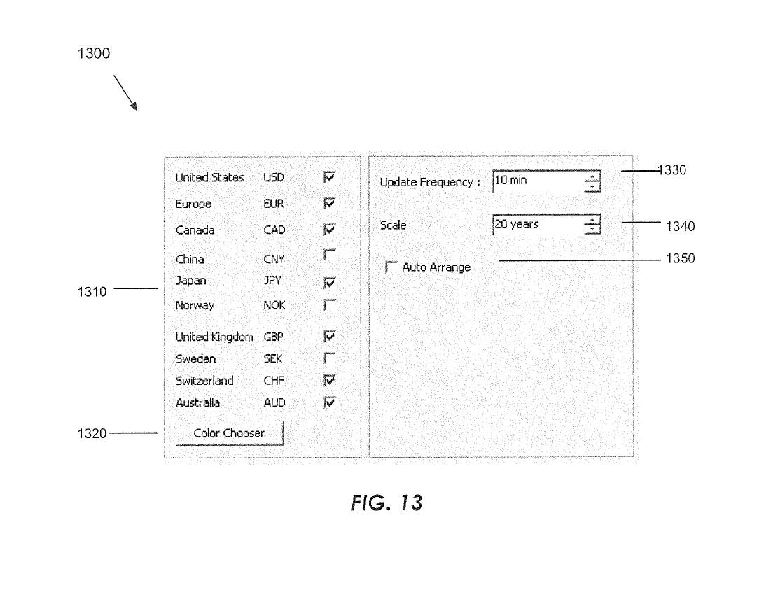

In addition, the financial data interface system 200 shows on the display screen 40 a menu interface 1300 in FIG. 13. The menu interface 1300 can be used for manipulating and displaying information to the user. In this example, the menu interface includes a plurality of currencies selection boxes. The user can select the currencies that are to be analyzed and displayed. A box for choosing an update frequency is provided, which is used by the financial data interface system 200 for analysis and display. Here 10 minutes is chosen, which means the system will update the display every 10 minutes, in this embodiment. The update preferably includes an update based on updated currency information. A scale is also provided, here “20 years” is chosen which determines the length of the time series used for computation and/or for display.

It is understood that the display of the financial data interface system 200 is illustrated according to one embodiment of the present invention and is not limited as such. For example, the currencies 1310 that a user can select from, the colors 1320, the time scale 1340, the update frequency 1330, may be modified in numerous ways. In addition, there is no limit to how many currencies 1310 are offered to the user, and how many he can select.

FIG. 8 shows a plurality of display regions 810-870, such as region 830 and 860, each corresponding to a distinct object, which in this embodiment refers to the strength of a currency over a period of time 880.

FIG. 9 illustrates a view of the screen on display 40 as generated by the financial data interface system 200, according to one embodiment of the present invention. In accordance with one embodiment of the present invention, the interface system 220 divides the available screen into, for example, seven display sectors 910-970. Instead of stacking the display regions like in FIG. 8, the display regions are shown separately, to improve the readability and comparability of the size of the regions, individually.

Variation: Data Information

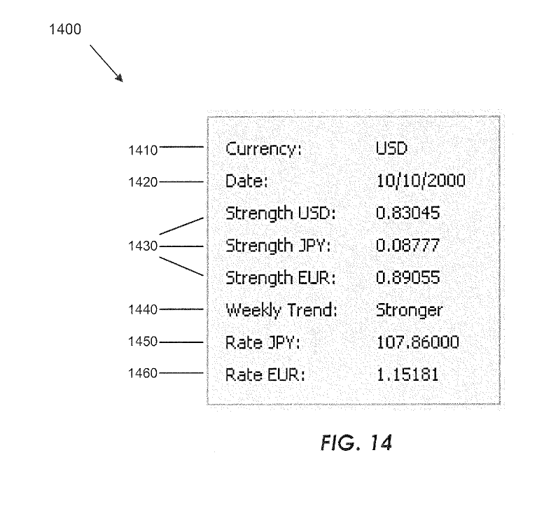

With reference to FIG. 14, an output 1400 is shown. The output takes the form of pop-up display 1400 of additional information that can be displayed to the user when a region is selected. One way of selecting a region is to move an input device 70, such as a mouse, so that the mouse pointer on the display screen 40 is located over a desired region, such as a displayed currency strength plot. In response, a pop-up display 1400 appears, showing additional information, such as currency name 1410, date 1420, currency strengths 1430, trends 1440, exchange rates to other currencies 1450-1460, but the invention is not limited to the display of this particular set of information. Other information can include trading volume, analyst recommendations, financial news, just to name a few of the endless possibilities. Alternatively, the information can also be shown on other regions of the display 40 without a separate pop-up window, or by other means.

Variation: User Manipulation

According to the present embodiment, financial data interface system 200 is configured via its various views, as shown in FIGS. 5, 7, 8, 9, 10 to graphically convey to the user information about the currency strength through the use of region size and color. Thus, for each region or currency the user can examine its graphical size and color to decipher the changes in the currency strength over time. In one embodiment, each color corresponds to one currency and is selected by the user. An additional modification, in one embodiment, can be the use of shading and/or different intensities. It is understood that these visual modifications may be modified in numerous ways.

With continued reference to the embodiments shown in FIGS. 5, 7, 8, 9-14, it is understood the many additional features can be added to the interface and function of the financial application.

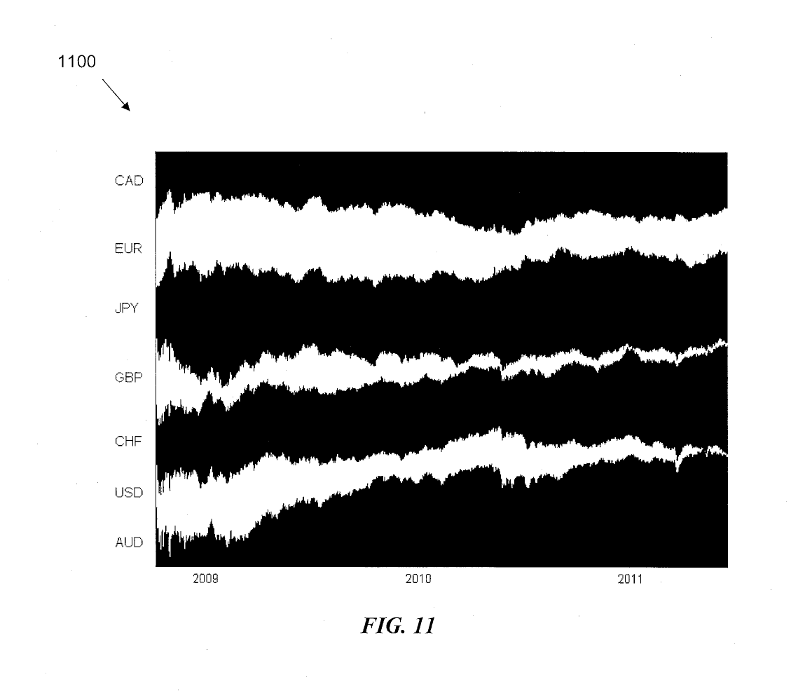

With reference to FIG. 11, for example, one portion of the display 40 of the financial data interface system 200 is enlarged and occupying the entire interface, according to one embodiment of the invention, showing, for example, a time span of 3 years instead of 20 years as in FIG. 8. The time region can be scaled to any desired size, for example an amount of years, months, days, hours, minutes, or seconds. One way of zooming into a desired region is by selecting a desired time frame via manipulation methods of the financial data interface system 200. Another way of zooming into a desired region is by selecting this region with an input device, for example, a mouse. It is understood that in another embodiment there may be other methods for manipulating the interface. As with FIG. 14, a pop-up display 1400 may be used to show additional information. As with FIG. 13, manipulation of the display may also be used here.

Again, it is noted that the interface screens described herein, provide only a limited number of embodiment in accordance with the present invention, which is not limited as such. Also, in other embodiments, the displayed data may show other financial ratios than the currency strength that have the same or similar characteristics, for example other financial ratios that have a parity or add up to the same value. Also, there might be alternative applications in addition to that of the financial industry.

As mentioned above, each of FIGS. 8-9 can be present on a display with a menu bar or other user interactive selection mechanism, such as interface 1300, with controls to facilitate any necessary tasks, and an information display 1400 to show additional information.

Optional Features, 1

FIG. 13 illustrates an optional feature, which may be included as a legend, menu, pop-up window, or any other method, and which is useful for controlling the criteria and visual indications of the financial data interface system 200. For example, the user may select the currencies 1310, may specify the colors for the currencies 1320, may vary the update frequency of the currency exchange data 1330, may modify the time scale 1340, or may chose that interface system to automatically arrange the ordering of the currencies 1350. It is understood, that the options to manipulate the selection or to change the display can be varied in manifold ways.

Optional Features, 2

FIG. 14 illustrates a second optional feature to the financial application of this embodiment 1400, which enables additional information to be displayed to the user for a more detailed analysis of a particular region of the display. One way of selecting a region is to move an input device 70, such as a mouse, so that the mouse pointer on the display screen 40 is located over a desired region. In response, a pop-up display 1400 appears, showing additional information, such as currency name 1410, date 1420, currency strengths 1430, trends 1440, exchange rates to other currencies 1450-1460, but not limited to these information. Other information can include trading volume, analyst recommendations, financial news, just to name a few of the endless possibilities. Alternatively, the information can also be shown on other regions of the display 40 without a pop-up window. It is understood, that graphical user interfaces today offer a wide variety of techniques to achieve various results.

With respect to the wide availability of financial data over networks today, such as the Internet, the software application of this invention can be used to provide the user detailed information about the development of currency strengths. For example, in one embodiment, the exchange rates can be updated over a network.

It is understood that the present invention is not limited to the embodiments as described hereinabove. In an alternative embodiment, the computer interface may be configured to use other financial measures, or areas other than the financial industry, especially if the data has parity and a time component, as it is the case with exchange rates.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1. A computer-implemented method of presenting changes in strength of currencies over time, the method comprising:
providing at least one computer processor coupled to at least one non-transitory storage media, and a display;
accessing currency exchange rates and electronically computing currency strengths for a plurality of selected currencies for a specified period of time, including computing a currency strength for each of the plurality of selected currencies relative to the other selected currencies; and
generating one or more display regions on the display, including presenting within the one or more display regions the currency strengths and relative changes in the currency strengths over time.

2. The method of claim 1, further comprising:
computing said currency strengths as currency strength indexes based on increases and decreases of the currency values over time, such that a sum of the currency strengths indexes for the plurality of currencies is substantially constant over time.

3. The method of claim 1, further comprising:
displaying a plurality of display regions on the display, each display region comprising at least one of the currency strengths, and automatically determining an ordering of the display regions based on the currency strengths.

4. The method of claim 1, further comprising:
displaying a plurality of display regions on the display, each display region comprising at least one of the currency strengths, and determining an ordering of the display regions in response to a user interaction via a user input device.

5. The method of claim 1, further comprising:
displaying additional information about each of said currencies in response to a command provided via a user input device.

6. The method of claim 1, further comprising:
updating said one or more display regions at predetermined time intervals.

7. The method of claim 1, wherein each of said display regions represents a corresponding currency strength, and a change of size of each display region over time corresponds to the change of said currency strength over time.

8. The method of claim 1, further comprising:
contiguously stacking said currency strengths within the display regions one above the other.

9. The method of claim 1, wherein a weakest point of relative currency strengths between at least two different currencies is 0.

10. The method of claim 1, further comprising:
generating on the display a menu interface having user-interactive mechanisms enabling manipulation and displaying of information related to the plurality of selected currencies.

11. The method of claim 1, further comprising:
generating on the display relevant data for individual regions from the one or more display regions within a pop-up display appearing when one of said regions is selected.

12. The method of claim 1, further comprising:
generating on the display an expanded display providing additional data related to the plurality of selected currencies and user options for interacting with the additional data.

13. The method of claim 1, further comprising:
generating on the display a zoom view of the currency strengths.

14. The method of claim 1, further comprising:
re-sizing the currency strengths at predetermined intervals, wherein the re-sizing reflects a change in financial data of the plurality of selected currencies.

15. The method of claim 1, further comprising:
positioning the currency strengths on the display according to a mathematical function employing variables comprising metrics of said currencies.

16. The method of claim 1, further comprising:
providing a user input mechanism to enable a user to modify the time scale of the one or more display regions.

17. A financial data interface system, comprising:
at least one computer processor coupled to at least one non-transitory storage media, and a display;
a financial data processor configured to access currency exchange rates and to compute currency strengths for a plurality of selected currencies and for a specified period of time, wherein a currency strength for each of the plurality of selected currencies is computed relative to the other selected currencies; and
output generator configured to generate one or more display regions on the display, wherein the one or more display regions present the currency strengths and relative changes in the currency strengths over time.

18. The system of claim 17, wherein the financial data processor is configured to compute the currency strengths as currency strength indexes that are computed based on increases and decreases of the currency exchange rates over time, such that a sum of the currency strengths indexes for the plurality of currencies is substantially constant over time.

19. The system of claim 17, wherein a plurality of display regions are displayed on the display, each display region comprising at least one of the currency strengths, wherein an ordering of the currency strengths is automatically determined.

20. The system of claim 17, wherein a plurality of display regions are displayed on the display, each display region comprising at least one of the currency strengths, wherein an ordering of the display regions is manually determined by user interaction with the financial data interface system via a user input device.

21. The system of claim 17, wherein additional information about each of said currencies is displayed in response to a command provided to the financial data interface system via a user input device.

22. The system of claim 17, wherein said one or more display regions are updated at predetermined time intervals.

23. The system of claim 17, wherein each of said display regions represents a corresponding currency strength, and a change of size of each display region over time corresponds to the change of said currency strength over time.

24. The system of claim 17, wherein said currency strengths within the display regions are contiguously stacked one above the other.

25. The system of claim 17, wherein a weakest point of relative currency strengths between at least two different currencies is 0.

26. The system of claim 17, wherein the output generator is further configured to generate on the display a menu interface having user-interactive mechanisms configured to manipulate and display information related to the plurality of selected currencies.

27. The system of claim 17, wherein the output generator is further configured to generate on the display relevant data for individual regions from the one or more display regions within a pop-up display appearing when one of said regions is selected.

28. The system of claim 17, wherein the output generator is further configured to generate on the display an expanded display providing additional data related to the plurality of selected currencies and user options for interacting with the additional data.

29. The system of claim 17, wherein the output generator is further configured to generate on the display a zoom view.

30. The system of claim 17, wherein the output generator is further configured to re-size the currency strengths at predetermined intervals reflecting a change in financial data of the plurality of selected currencies.

31. The system of claim 17, wherein the output generator is further configured to position the currency strengths on the display according to a mathematical function employing variables comprising metrics of said currencies.

32. The system of claim 17, wherein the output generator is further configured to provide a user input mechanism to enable a user to modify the time scale of the one or more display regions.

33. A computer-implemented method of presenting changes in strength of currencies over time, the method comprising:
providing at least one computer processor coupled to at least one non-transitory storage media, and a display;
accessing currency exchange rates and electronically computing currency strengths for a plurality of selected currencies for a specified period of time, including computing a currency strength for each of the plurality of currencies relative to the other selected currencies and computing said currency strengths as currency strength indexes based on increases and decreases of the currency exchange rates over time, such that a sum of the currency strengths indexes is substantially constant over time; and
generating one or more display regions on the display, including presenting the computed currency strength indexes for the plurality of selected currencies over time, including presenting relative changes in the currency strength indexes over time and contiguously stacking said currency strength indexes within the display regions one above the other.
